(19) United States
(12) Patent Application Publication
(10) Pub. No.: US 2009/0307957 A1
(43) Pub. Date: Dec. 17, 2009

(54) SCENT DISPERSAL DEVICE

(76) Inventors: Kim R. GASS, Portage, WI (US); Clyde H. Masten, III, Portage, WI (US)

Correspondence Address: LATHROP & CLARK LLP, 740 REGENT STREET SUITE 400, P.O. BOX 1507, MADISON, WI, 537011507, US

(21) Appl. No.: 12/485,584

(22) Filed: Jun. 16, 2009

Related U.S. Application Data
(60) Provisional application No. 61/132,158, filed on Jun. 16, 2008.

(51) Int. Cl. A01M 31/00

(52) U.S. Cl. 43/1

(57) ABSTRACT

A scent dispersal device includes a reservoir usable to hold a scented material that emits a desired scent. A rate-controllable valve regulates a fluid connection between the reservoir and the external environment. The rate-controllable valve may be adjustable to alter the flow rate of the scent substance from the reservoir to the external environment. The scent dispersal device may also include a vent usable to reduce a pressure differential between the reservoir and the external environment and/or to facilitate the movement of air, the ambient atmosphere and/or another gas into the reservoir.

### CROSS REFERENCE TO RELATED APPLICATION

This application claims priority to U.S. Provisional Application 61/132,158, filed Jun. 16, 2008, which is incorporated herein by reference in its entirety.

### BACKGROUND

1. Field

This invention is generally related to scent dispersal devices. This invention is more particularly related to scent dispersal devices usable while hunting a game animal.

2. Background

Animals are known to react to various stimuli, including scents. For example, many game animals, such as deer, are particularly attracted to, intrigued by, startled by and/or repelled by certain scents (e.g., pheromones of other animals or scents of humans, such as, for example, fragrances from soaps). By placing, simulating and/or releasing appropriate scents at desired locations, hunters can entice animals to behave in desired manners (e.g., approach a tree stand, avoid a campsite, etc). For example, hunters often use attractant scents to help lure game animals to their location. Additionally, hunters often use various scent applicators to hide, mask or alter their own scent to avoid alarming game animals to their presence.

### SUMMARY

Many animals (e.g., game animals) have particularly acute senses of smell. For such animals, scents may indicate the presence of a threat, a potential mate, a territorial intruder and/or a source of food, as well as various other indications about the local environment. As such, animals may become curious about, attracted to or repelled by particular scents.

It should be appreciated that animals may be attracted to, intrigued by or repelled by different scents for various reasons. For example, a buck, or male deer, may be attracted to the scent of an estrus doe (e.g., a female deer in heat or a female deer in a receptive stage of the reproductive cycle who will accept a mate and is capable of conception) by a desire to mate with the doe. Likewise, a buck may be attracted to a scent of a second buck by a desire to declare dominance over, protect a territory from, or pursue a mate of, the second buck. The scent of an estrus doe and/or a buck may be reproduced or imitated by collecting and redistributing urine from a donor animal and/or by using a synthetic composition designed to simulate the scent of an estrus doe and/or a buck. Likewise, other desired scents may be reproduced or imitated using any known or later-developed natural and/or synthetic substance.

As outlined above, hunters often take advantage of a game animal's receptiveness or reaction to various scents to help entice the game animal to behave in a desired manner. For example, hunters often use sent lures to entice a game animal to approach a desired location (e.g., within a clear line-of-sight of a tree stand). Additionally, hunters may use various scent devices (e.g., scent neutralizing agents) and/or intentionally scent-free products (e.g., scent free soaps, shampoos, laundry detergents, etc.) to help reduce or eliminate scents which would otherwise be emitted by the hunter. Likewise, hunters may use various scent products to mask or cover their own scent with that of another animal, such as, for example, a raccoon or a fox.

Regardless of the reason (e.g., to attract an animal, to repel an animal, to cover one's own scent, etc.), hunters often wish to be able to mark an artificial scent path (e.g., a trail of a distributed substance that may emit a desired scent that approximates and/or imitates a natural scent trail left by an animal). For example, a hunter may desire to provide an artificial scent path to imitate a doe traveling through an area near a tree stand in order to entice bucks in the area to approach the tree stand in search of the imitated doe. Likewise, a hunter may desire to leave a trail that simulates and/or imitates a natural scent trail of a local animal and/or a scent trail that counteracts the hunter's own scent trail. Such a scent trail may help cover or mask the hunter's own scent trail while that hunter travels (e.g., to a tree stand), and thereby may reduce the likelihood that animals in the area will be alerted to the hunter's presence.

Traditionally, hunters use squirt bottles or the like to provide a scent trail. Such squirt bottles require a free hand to operate, are cumbersome and limite the other functions the hunter can perform (e.g., prepare to fire a weapon). Likewise, a hunter must remember to bring the squirt bottle when the hunter moves from one location to another and must remember to actively disperse the scent substance as the hunter travels.

Another traditional method of providing a scent trail involves using a cloth or pad attached to a hunter's foot (e.g., on a bottom surface of the hunter's shoe). The cloth or pad is saturated with a scented liquid which is passed to the ground as the hunter walk. Such cloths or pads are prone to drying out during extended periods of non-movement, are not efficient with their use of scent substance and provide intermittent blotched scent patterns, which may not be consistent with natural scent paths.

A third traditional method of providing a scent trail involves dragging a tube behind the hunter as the hunter travels. The tube is connected to a reservoir, which contains a scented liquid. The scented liquid travels down the tube and onto the ground as the hunter travels. Such tube-based methods can disturb the ground and local foliage as the hunter travels, leaving a visual trail and producing noise. Additionally, such tube-based methods may continue releasing scent substance when the hunter is not moving, thereby wasting scent substance and possibly over saturating a location and counteracting the desired effect.

In various exemplary embodiments, a scent dispersal device according to this invention dispenses a scent substance at a controlled rate. In various exemplary embodiments, as the hunter moves, the scent dispersal device periodically releases small proportions (e.g., drops) of the scent substance to create a trail of the scent substance. In various exemplary embodiments, the rate at which the scent substance is released can be adjust and/or stopped.

In various exemplary embodiments, the scent dispersal device includes a controllable valve that can be adjusted to alter the rate at which a scent substance passes through the valve. In various exemplary embodiments, the scent dispersal device includes a passive valve that automatically adjusts a rate of flow in proportion to a rate of movement of the scent dispersal device. In one such exemplary embodiment, a ball bearing valve reacts to movement of the scent dispersal device by releasing a scent substance.

In various exemplary embodiments, the scent dispersal device includes a needle valve that can be adjusted to alter and/or stop the rate of flow of the scent substance being distributed by the scent dispersal device.

A scent dispersal device includes a reservoir usable to contain a supply of a scented material. The reservoir includes a fastener usable to attach the scent dispersal device to a traveling object (e.g., the user or an object carried by the user). The scent dispersal device also includes an outlet and a rate controllable-valve usable to adjust or control the rate of flow of the scented material through the outlet of the reservoir.

A method of providing a scent trail includes attaching a scent dispersal device to a traveling object (e.g., the user or an object carried by the user). The scent dispersal device includes a reservoir usable to contain a supply of a scented material, an outlet, and a rate-controllable valve usable to control a rate of flow of the scented material through the outlet of the reservoir. The method also includes adjusting the rate-controllable valve to dispense the scented material through the outlet of the reservoir at a desired rate of flow and traveling a desired path of the scent trail.

These and other features and advantages of various exemplary embodiments of systems and methods according to this invention are described in, or are apparent from, the following detailed descriptions of various exemplary embodiments of various devices, structures and/or methods according to this invention.

### BRIEF DESCRIPTION OF DRAWINGS

Various exemplary embodiments of the systems and methods according to this invention will be described in detail, with reference to the following figures, wherein:

FIG. 1-3 are top, front and side plan views, respectively, of an exemplary embodiment of a scent dispersal device according to this invention;

FIG. 4 is an exploded view of the scent dispersal device shown in FIGS. 1-3;

FIGS. 5-9 are isometric, front plan, side plan, rear plan and cross-sectional views, respectively, of one embodiment of a front portion of the scent dispersal device shown in FIG. 4;

FIGS. 10-14 are isometric, front plan, top plan, side plan and rear plan views, respectively, of one embodiment of a rear portion of the scent dispersal device shown in FIG. 4;

FIG. 15 is a cross-sectional view of the front portion and rear portion as seen from line 15-15 in FIG. 1;

FIGS. 16-18 are front plan, cross-sectional and side plan views, respectively, of one embodiment of a valve of the scent dispersal device shown in FIG. 4;

FIG. 19 is a cross-sectional view of the front portion, rear portion and valve as seen from line 19-19 in FIG. 2;

FIGS. 20-23 are top plan, cross-sectional, side plan and bottom plan views, respectively, of one embodiment of a reservoir cap of the scent dispersal device shown in FIG. 4; and

FIGS. 24-26 are side plan, top plan and cross section views, respectively, of one embodiment of a vent cap of the scent dispersal device shown in FIG. 4.

### DETAILED DESCRIPTION

It should be appreciated that the following description of a scent dispersal device is in relation to use by a hunter for hunting animals. However, any individual could use the described scent dispersal device for any desired purpose. For example a nature photographer may use the scent dispersal device to help approach or be approached by desired animals. As such, the following description (e.g., with regard to use by hunters) should be appreciated to include use by any user(s) who may use the scent dispersal device for any desired purpose.

As outlined above, it may be advantageous and/or desired for a hunter to provide a scent trail (e.g., of an attractive scent or of a masking scent) as the hunter travels through a hunting area. Further, it may be preferable for the scent trail to be provided without unnecessary intervention from the hunter.

In various exemplary embodiments, a scent dispersal device is a passive device (e.g., not requiring interaction by the user beyond desired adjustments), which is attached to a traveling object (e.g., the hunter or the hunter's hunting equipment). For example, the scent dispersal device may be strapped to the hunter's ankle or clipped to a garment or bag that is worn or carried by the hunter.

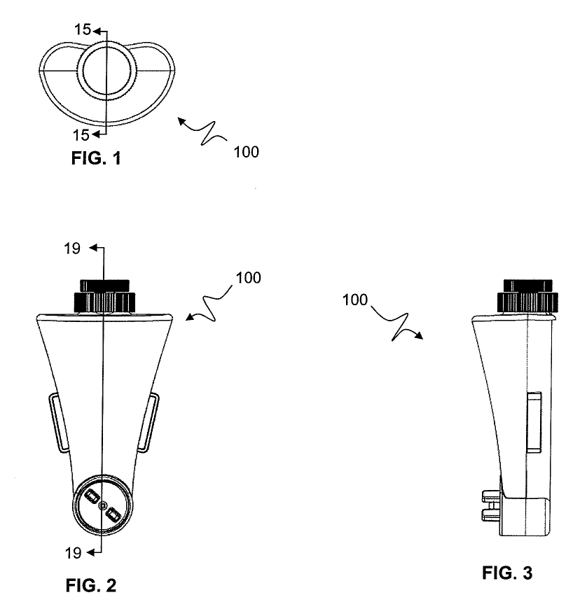

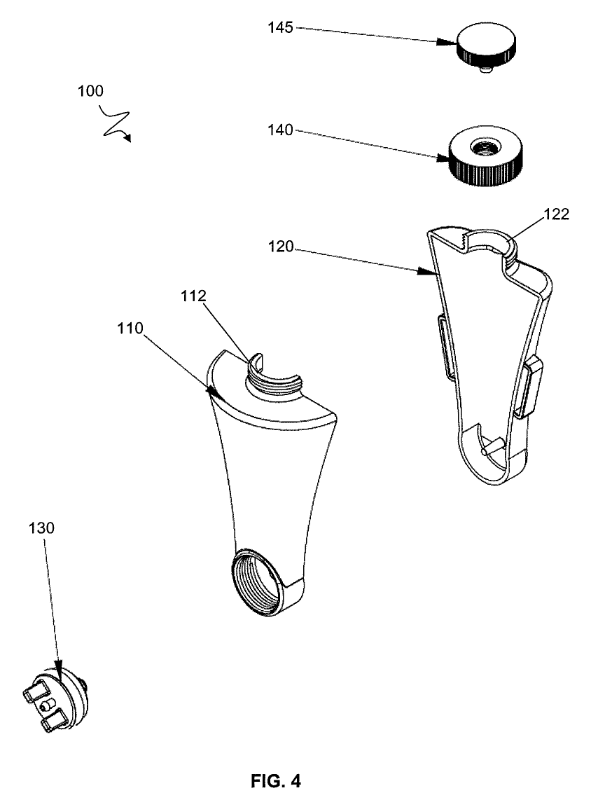

FIGS. 1-3 are top, front and side plan views, respectively, of an exemplary embodiment of a scent dispersal device 100 according to this invention, which is usable to provide a trail of a desired scent as a hunter travels with the scent dispersal device 100. FIG. 4 is an isometric exploded view of the scent dispersal device 100. As shown in FIGS. 1-4, the scent dispersal device 100 includes a front portion 110, which includes a partial, threaded projection 112; a rear portion 120, which includes a partial, threaded projection 122; a valve 130; a reservoir cap 140 and a vent cap 145.

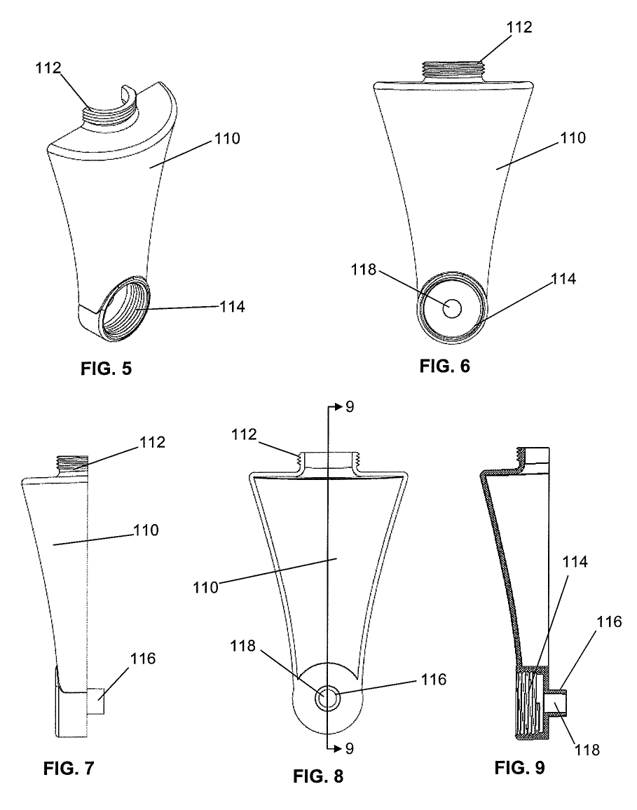

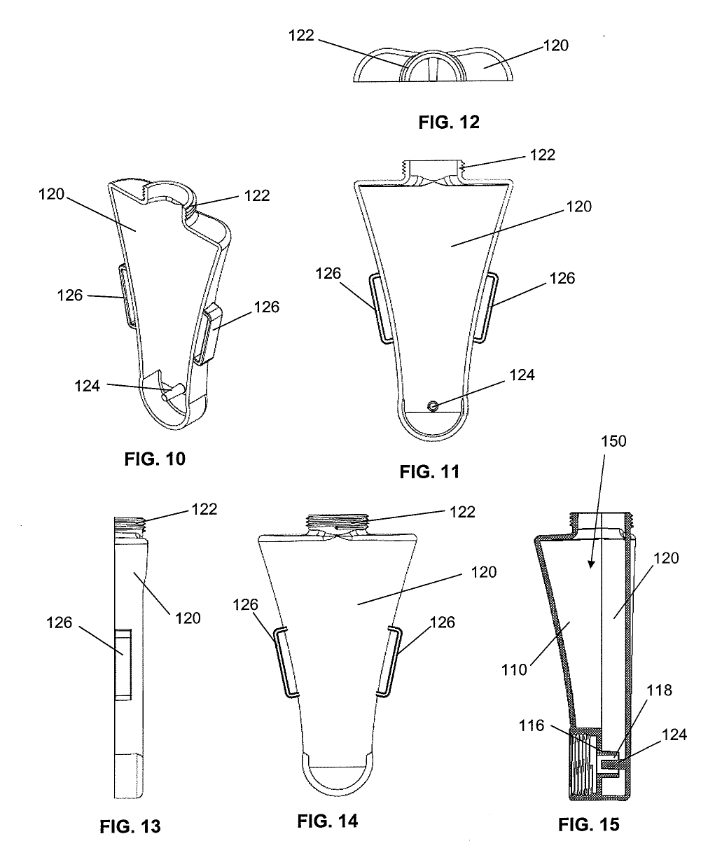

FIGS. 5-9 are isometric, front plan, side plan, rear plan and cross sectional views, respectively, of one embodiment of the front portion 110, including the partial, threaded projection 112, of the exemplary embodiment of the scent dispersal device 100. FIGS. 10-14 are isometric, front plan, top plan, side plan and rear plan views, respectively, of one embodiment of the rear portion 120, including the partial, threaded projection 122, of the exemplary embodiment of the scent dispersal device 100. It should be appreciated that, in the exemplary embodiment shown in FIGS. 1-13, the front portion 110 and the rear portion 120 interact to define a reservoir. Likewise, the partial, threaded projection 112 of the front portion 110 and the partial, threaded projection 122 of the rear portion 120 interact to provide a complete, threaded projection. It should also be appreciated that any number of portions, including any number of partial, threaded projections, may be utilized to provide the reservoir. In various other exemplary embodiments, the reservoir is formed as a single piece with a complete, threaded projection.

It should be appreciated that any individual threads of each partial, threaded projection (e.g., the partial, threaded projections 112 and 122 of the front and rear portions 110 and 120, respectively) may not be interconnected until all of the partial, threaded projections are coupled together. That is, while the complete threaded projection may include interconnected threads as typically found on a threaded projection, each individual partial, threaded projection may not include interconnected threads.

Further, it should be appreciated that, in various exemplary embodiments, the complete, threaded projection (e.g., the combination of the partial, threaded projections 112 of the front portion and the partial threaded projection 122 of the rear portions) includes an aperture (e.g., an inlet) that provides access to an interior of the scent dispersal device 100 (e.g., to fill the scent dispersal device 100 with a scent substance).

It should also be appreciated that the front portion 110 and the back portion 120 of the scent dispersal device 100, or any other portions which may make up the scent dispersal device 100, may be coupled together using any desired known or later-developed device or method. In general, the front portion 110 and the back portion 120 are coupled together in a manner that provides a generally fluid-proof seal at the junction between the front portion 110 and the back portion 120, such that a fluid provided in the interior of the scent dispersal device 100 will not leak out through the junction between the front portion 110 and the back portion 120, or any other portions that make up the scent dispersal device 100. In various exemplary embodiments, the front portion 110 and the rear portion 120 are sonic, vibration and/or heat welded together.

In general, the scent dispersal device 100 is usable to hold a scent substance (e.g., a substance that is usable to emit a desired scent). It should be appreciated that the scent substance may be any known or later-developed substance that is usable to provide or imitate a scent detectable by an animal. In various exemplary embodiments, the scent substance is a liquid. In various other exemplary embodiments, the scent substance is a solid (e.g., a powder or a collection of pellets). In various exemplary embodiments, the scent substance is a fluid, in that it is a flowable substance (e.g., a liquid, a gas, a flowable solid, etc.).

As shown in FIGS. 5 and 6, the front portion 110 also includes a threaded depression 114, which extends toward a rear of the front portion 110 (e.g., into an interior of the scent dispersal device 100 when the front portion 110 is coupled to the rear portion 120). As shown in FIG. 7, a projection 116 extends further from the rear of the front portion 110 (e.g., into an interior of the scent dispersal device 100 when the front portion 110 is coupled to the rear portion 120). FIG. 9 is a cross-sectional view of the front portion 110 as seen from the line 9-9 in FIG. 8, showing how the threaded depression 114 and the projection 116 extend toward a rear of the front portion 110 (e.g., to the right, as seen in FIG. 9). As shown in FIGS. 6-9, an aperture 118 extends through the threaded depression 114 and the projection 116. It should be appreciated that, in various exemplary embodiments, the projection 116 at least partially defines the aperture 118.

As shown in FIGS. 10 and 11, the rear portion 120 includes a plunger 124 extending forward from the rear portion (e.g., into an interior of the scent dispersal device 100 when the rear portion 120 is couple to the front portion 110). The rear portion 120 also includes two fastening loops 126. The fastening loops 116 may be used to secure a fastener around the scent dispersal device 100. The fastener (e.g., a belt, a strap or the like) can then be used to secure the scent dispersal device 100 to a traveling object, such as, for example, the user (e.g., by strapping the scent dispersal device 100 to the user's ankle) or an object carried by the user (e.g., by tying the scent dispersal device to a bag, which is carried by the user).

It should be appreciated that in various exemplary embodiments, the fastening loops 126 may be provided in other locations on the scent dispersal device 100. For example, in various other exemplary embodiments, the fastening loops 126, or similar structures, are provided on the front portion 110 of the scent dispersal device 100. Likewise, other structures may be used in addition to or in place of the fastening loops 126 to attach the scent dispersal device 100 to a desired object (e.g., a user's ankle). For example, a single loop may be provided on the back surface of the rear portion 120 and/or a belt hook, clip, carabineer, or other structure may be provided at any desired location on scent dispersal device 100. In general any known or later-developed attachment structure, system or method may be utilized to attach the scent dispersal device 100 to a desired object.

FIG. 15 is a cross-sectional view of the front portion 110 and the back portion 120 coupled together, along the line 15-15 in FIG. 1. As shown in FIG. 15, when the front portion 110 and the back portion 120 are coupled together, the define a reservoir 150 and the plunger 124 of the back portion 120 extends into the aperture 118 of the projection 116 of the front portion 110. It should be appreciated that, while the plunger 124 extends into the aperture 118, the plunger 124 does not touch the projection 116, and thus, does not close, plug or seal the aperture 118. As such, a fluid connection is maintained between the interior of the scent dispersal device 100 (e.g., the reservoir 150) through the aperture 118.

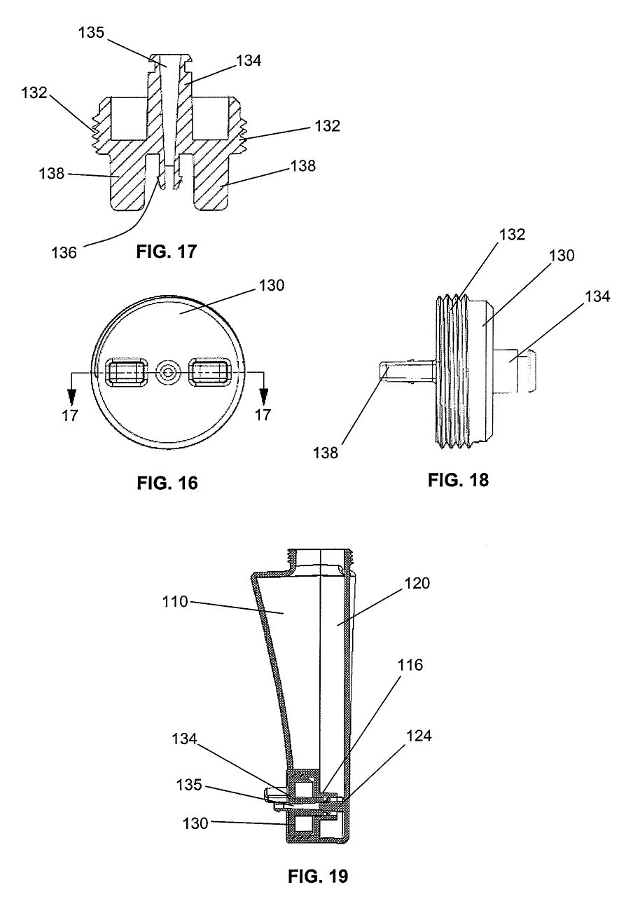

FIGS. 16, 17 and 18 are front plan, cross-section and side plan views, respectively, of one embodiment of a valve 130 usable with the exemplary embodiment of the scent dispersal device 100. Specifically, FIG. 17 is a cross-sectional view of the valve 130 as seen from line 17-17 in FIG. 16. As shown in FIGS. 16-18, the valve 130 includes a threaded outer surface 132, a seat projection 134, an outlet head 136 and two finger grips 138. An orifice 135 extends between the seat projection 134 and the outlet head 136 to provide a fluid connection through the valve 130.

The thumb grips 138 help a user thread the valve 130 into and/or out of the threaded depression 114 of the front portion 110. As the valve 130 is threaded into and/or out of the threaded depression 114, the threaded outer surface 132 of the valve 130 interacts with the threaded walls of the threaded depression 114. It should be appreciated that, in various exemplary embodiments, the valve 130 may include any number of thumb grips 138. Further, in various exemplary embodiments, the thumb grips 138 may be omitted and/or supplemented or replaced with various other structures that may facilitate easy interaction between a user and the valve 130.

FIG. 19 shows a cross-sectional view, as seen from line 19-19 in FIG. 2, of the front portion 110 and the back portion 120 coupled together with the valve 130 threaded into the threaded depression 114 of the front portion 110. As shown in FIG. 19, as the valve 130 is threaded into the threaded depression 114, the seat projection 134 interacts with the plunger 124 to restrict or reduce the flow of a fluid through the aperture 118 and the orifice 135. Likewise, as the valve 130 is threaded out of the threaded depression 114, the seat projection 134 separates from the plunger 124, and the flow of fluid through the aperture 118 and the orifice 135 increases. It should be appreciated that, in various exemplary embodiments, the valve 130 may be threaded sufficiently into the threaded depression 114 such that the seat projection 134 engages or contacts the plunger 134 sufficiently that the flow of fluid through the aperture 118 and the orifice 135 effectively stops.

It should be appreciated that, in various exemplary embodiments, other valve structures may be used in addition to or in place of the valve 130. For example, in various exemplary embodiments, a ball bearing valve that utilizes ball bearings to selectively open or close an outlet of the reservoir 150 may be used to controllably release the scent substance from the reservoir 150. In various exemplary embodiments, a ball bearing valve reacts to the kinetic motion of the scent dispersal device 100 to adjust the rate of flow of the scent substance from the reservoir 150 to the external environment. For example, as the scent dispersal device 100 moves, a ball bearing in a ball bearing valve may be displaced, creating a fluid connection between the reservoir 150 and an outlet of the scent dispersal device 100. As the ball bearing returns to its original position, the fluid connection is severed. As such, the ball bearing valve self adjusts to alter the rate of flow of the scent substance in relation to the movement of the scent dispersal device 100.

It should be appreciated that, in various exemplary embodiments, the valve 130 may utilize gravity, capillary action or other passive forces to aid the scented substance to flow out of the valve 130. Additionally, the scented substance in the reservoir 150 may be at a pressure that is greater than an ambient pressure outside of the reservoir 150. As such, when the valve 130 is opened, the pressure differential between the scented substance within the reservoir 150 and the ambient pressure forces the scented substance out of the reservoir 150 through the valve 130.

It should be appreciated that the pressure differential between the scented substance within the reservoir 150 and the ambient pressure may be provided using any known or later-developed device or method. In various exemplary embodiments, the scented substance is provided at the higher pressure. In various exemplary embodiments, the scent dispersal device 100 includes structures usable to increase the pressure of the scented substance within the reservoir 150. For example, in various exemplary embodiments, the scent dispersal device 100 may include a connection to a source of pressurized (e.g., a CO2 cartridge) that provides a pressure to the reservoir 150 of the scent dispersal device. Likewise, the scent dispersal device 100 may include a needle valve (e.g., a valve similar to those found on athletic sports balls) for supplying a gas to the reservoir 150 to increase the pressure within the reservoir 150. In such pressurized embodiments, varying the pressure of the reservoir 150 may provide flow rate control in place of or in addition to the valve 130.

In various exemplary embodiments, the scent dispersal device 100 includes an active valve in addition to or in place of the valve 130. In such exemplary embodiments, the active valve may include a power source and/or a controller usable to adjust the rate of flow through the active valve. In various exemplary embodiments, the active valve is an electromechanical valve (e.g., a solenoid valve) and includes a controller usable to adjust a rate of flow through the electromechanical valve.

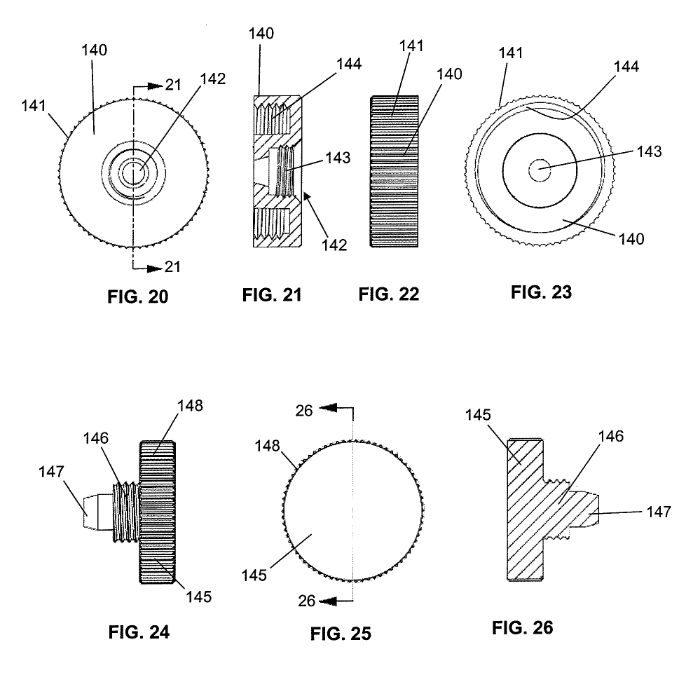

FIGS. 20-23 are top plan, cross-sectional, side plan and bottom plan views, respectively, of one exemplary embodiment of the reservoir cap 140. The reservoir cap 140 is usable to close, cover and/or seal an inlet of the reservoir 150 (e.g., the inlet formed in the complete, threaded projection when the partial threaded projection 112 of the front portion 110 and the partial, threaded projection 122 of the rear portion 120 are coupled together). As shown in FIGS. 20 and 22, in various exemplary embodiments, the reservoir cap 140 includes a textured outer surface 141. As shown in FIG. 20, in various exemplary embodiments, the reservoir cap 140 includes a vent orifice 142. The vent orifice 142 provides a fluid connection between the reservoir 150 and an external environment when the reservoir cap 140 is used to cover an inlet of the reservoir 150. FIG. 21 is a cross-sectional view of the reservoir cap 140 as seen from the line 21-21 in FIG. 20. As shown in FIG. 21, in various exemplary embodiments, the vent orifice 142 includes a threaded inner surface 143.

Additionally, the reservoir cap 140 includes a threaded inner depression 144. In the exemplary embodiment shown in FIGS. 1-23, the threaded inner depression 144 of the reservoir cap 140 interacts with the complete, threaded projection formed when the partial, threaded projection 112 of the front portion and the partial, threaded projection 122 of the read portion are coupled together.

FIGS. 24-26 show side plan, top plan and cross-sectional views, respectively, of one exemplary embodiment of the vent cap 145. The vent cap 145 is usable to close, cover and/or seal the vent orifice 142 in the reservoir cap 140. As shown in FIG. 24, the vent cap 145 includes a threaded projection 146, which includes a plunger 147. In various exemplary embodiments, the plunger is formed of plastic, rubber and/or some material that facilitates forming a seal with the vent orifice 142 of the reservoir cap 140. As shown in FIGS. 24 and 25, in various exemplary embodiments, the vent cap 145 includes a textured outer surface 148. The textured outer surface 148 may help facilitate an interaction between a user and the vent cap 145 (e.g., by improving the grip or friction of the vent cap 145 as a user rotates the vent cap 145).

In various exemplary embodiments, the vent cap 145 is usable to close, cover or seal the vent orifice 142 in the reservoir cap 140. In various exemplary embodiments, the threaded projection 146 of the vent cap 145 interacts with the threaded inner surface 143 of the vent orifice 142 as the vent cap 145 is threaded into or out of the vent orifice 142. It should be appreciated that when the vent cap 145 is sufficiently threaded into the vent orifice 142, the fluid connection through the reservoir cap 140 between the reservoir 150 and the external environment may be effectively cut off. Likewise, by threading the vent cap 145 at least partially out of the vent orifice 142, the fluid connection can be restored and/or increased.

It should be appreciated that, in various exemplary embodiments, the reservoir cap 140 and the vent cap 145 are usable to close, cover or seal an inlet to the reservoir 150. As such, the reservoir cap 145 may be removed to provide access to the inlet to, for example, add a scent substance to the reservoir 150. Additionally, in various exemplary embodiments, the vent cap 145 may be used to facilitate the flow of air into the reservoir 150 to, for example, displace the scent substance as the scent substance exits through the valve 130.

It should be appreciated that, in various exemplary embodiments, any suitable known or later-developed vent and/or venting structure may be used in place of or in addition to the above-outlined reservoir cap 140 and vent cap 145. For example, a push top may be provided to cover an opening of the reservoir 150. Likewise, a pop vent, similar to those found on traditional gas cans, may be used to reduce or potentially eliminate a pressure difference between the reservoir 150 and the ambient environment and/or to facilitate the movement of air, the ambient atmosphere and/or some other fluid into the reservoir 150.

In an exemplary embodiment of a method for using the scent dispersal device 100, a hunter tightens the valve 130 to the front portion 110 (e.g., threads the valve 130 into the threaded depression 114 until the seat projection 134 sufficiently interacts with the plunger 124 to cut off the fluid connection from the reservoir 150 to the orifice 135). The hunter then introduces a scent substance into the reservoir 150 (e.g., by pouring a scented liquid through the inlet of the complete, threaded projection). The reservoir cap 140, with the vent cap 145 threaded into the vent cap 140, is then threaded onto the complete, threaded projection. The hunter then straps the scent dispersal device 100 to his or her leg using a strap that is threaded through the fastening loops 126 and around the hunter's leg.

To begin providing the scent trail, the hunter opens the vent orifice 142 (e.g., threads the vent cap 145 at least partially out of the vent orifice 142) and opens the valve 130 (e.g., threads the valve 130 at least partially out of the threaded depression 114) until the scent substance begins to flow out of the outlet head 136 at the desired rate. The hunter then travels the desired path of the scent trail. When the hunter reaches the end of the desired path or has reached a desired destination, the hunter may then stop the flow of the scent substance (e.g., by closing the valve 130 and/or the vent orifice 142) or alter (e.g., reduce) the rate of flow of the scent substance. In various exemplary embodiments, the hunter may remove the scent dispersal device 100 and attach the scent dispersal device to an object at the desired location (e.g., by using the strap to hang the scent dispersal device 100 from a tree branch). In various exemplary embodiments, the hunter may travel to a desired location with the scent dispersal device 100 distributing the scent substance at a first rate of flow and then alter the flow rate to continue distributing the scent substance at the desired location.

While this invention has been described in conjunction with the exemplary embodiments outlined above, various alternatives, modifications, variations, improvements and/or substantial equivalents, whether known or that are or may be presently foreseen, may become apparent to those having at least ordinary skill in the art. Accordingly, the exemplary embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

1. A scent dispersal device, comprising:
a reservoir usable to contain a supply of a scented material and including an outlet;
a fastener usable to attach the scent dispersal device to at a traveling object; and
a rate-controllable valve usable to allow a flow of the scented material through the outlet of the reservoir and to adjust a flow rate of the flow of the scented material through the outlet of the reservoir, wherein the rate controllable valve can be adjusted to selectively shut off the flow of the scented material through the outlet of the reservoir.

2. The scent dispersal device of claim 1, wherein the reservoir further includes an inlet, the scent dispersal device further comprising a cover usable to selectively close the inlet of the reservoir.

3. The scent dispersal device of claim 1, further comprising a vent usable to facilitate movement of a gas into an interior of the reservoir.

4. The scent dispersal device of claim 3, wherein the gas displaces the scented material as the scented material passes through the outlet.

5. The scent dispersal device of claim 3, wherein the vent includes a vent cover usable to seal the vent.

6. The scent dispersal device of claim 1, wherein the reservoir is capable of containing the scented material at a pressure greater than an ambient pressure outside the reservoir.

7. The scent dispersal device of claim 1, wherein the rate-controllable valve is a needle valve.

8. The scent dispersal device of claim 1, wherein the rate-controllable valve is a ball-bearing valve.

9. The scent dispersal device of claim 1, wherein the rate-controllable valve is a solenoid valve.

10. A method of providing a scent trail, comprising:
attaching a scent dispersal device to a traveling object, the scent dispersal device including a reservoir containing a supply of scented material and an outlet with a rate-controllable valve controlling a rate of flow of the scented material through the outlet;
adjusting the rate-controllable valve to dispense the scented material through the outlet of the reservoir at a desired rate of flow; and
traveling a desired path of the scent trail.

11. The method of claim 10, further comprising adjusting the rate-controllable valve at least once while traveling the desired path of the scent trail.

12. The method of claim 10, further comprising adjusting a vent to facilitate the movement of air into an interior of the reservoir.

13. The method of claim 10, further comprising adjusting the rate-controllable valve to shut off the rate of flow of the scented material through the outlet of the reservoir.

14. A method of providing a scent trail using a scent dispersal device attached to a traveling object, the scent dispersal device including a reservoir containing a supply of scented material and an outlet with a rate-controllable valve controlling a rate of flow of the scented material through the outlet, the method comprising:
adjusting the rate-controllable valve to dispense the scented material through the outlet of the reservoir at a desired rate of flow; and
traveling a desired path of the scent trail.

15. The method of claim 10, further comprising adjusting the rate-controllable valve at least once while traveling the desired path of the scent trail.

16. The method of claim 10, further comprising adjusting a vent to facilitate the movement of air into an interior of the reservoir.

17. The method of claim 10, further comprising adjusting the rate-controllable valve to shut off the rate of flow of the scented material through the outlet of the reservoir.
